(19) United States
(12) Patent Application Publication
(10) Pub. No.: US 2007/0034439 A1
(43) Pub. Date: Feb. 15, 2007

(54) Safety device for a motor vehicle

(75) Inventor: Thomas Hasbach, Bundesrepublik (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/500,771

(22) Filed: Aug. 8, 2006

(30) Foreign Application Priority Data
Aug. 10, 2005 (DE) 20 2005 012 564.4

(51) Int. Cl. B60R 21/00; B60R 22/36; B60R 21/16

(52) U.S. Cl. 180/268; 280/806; 280/730.1; 280/735

(57) ABSTRACT

A safety device for a motor vehicle includes a vehicle occupant protection arrangement installed as a unit in the vehicle and an electric impact sensor (24). The vehicle occupant protection arrangement installed as a unit in the vehicle and the electric impact sensor (24) form a preassembled unit.

### TECHNICAL FIELD

The invention relates to a safety device for a motor vehicle, in particular to a safety device comprising a vehicle occupant protection arrangement installed as a unit in the vehicle and an electric impact sensor. The invention further relates to a vehicle occupant protection system in a motor vehicle comprising such a safety device.

### BACKGROUND OF THE INVENTION

Modern vehicles nowadays have a large number of technical measures to protect the vehicle occupants. An example of these are airbag restraint systems the activation of which depends on the data of corresponding electric sensors (for frontal, side and rear impact), or electric belt retractors which make a reversible belt tensioning possible. The expenditure for installing the individual components of the vehicle occupant protection systems reaches a considerable amount, which accordingly has a detrimental effect on the total costs.

It is an object of the invention to reduce the expenditure when installing components of a vehicle occupant protection system.

### BRIEF SUMMARY OF THE INVENTION

According to the invention a safety device for a motor vehicle comprises a vehicle occupant protection arrangement installed as a unit in the vehicle, and an electric impact sensor. The vehicle occupant protection arrangement installed as a unit in the vehicle and the electric side impact sensor form a preassembled unit. The invention is based on the finding that the combination of the vehicle occupant protection arrangement and the electric impact sensor into a preassembled unit results in advantages in logistics even if the electric impact sensor is not a functional component of the particular vehicle occupant protection arrangement.

In accordance with a particularly preferred embodiment of the invention, the vehicle occupant protection arrangement is a belt retractor. The impact sensor involved is not the usual mechanical vehicle/belt-sensitive sensor used for blocking the belt retractor, but is preferably a side impact sensor for activating a side airbag module of the vehicle. A belt retractor and an electric side impact sensor are often installed not far away from each other, e.g. in the region of the B-column of a vehicle, so that the deviation from the previous mounting location is not relevant or can be compensated for by a suitable design. Moreover, both an electric sensor for detecting an impact and a belt retractor require a sturdy, resistant fastening. Combining a belt retractor and an electric impact sensor into one assembly unit makes handling considerably simpler, because this assembly unit can be delivered in a pre-assembled form as a “package”. The expenditure for installing the sensor is dispensed with entirely.

The belt retractor usually has its own housing. The electric impact sensor may either be fitted to the outside of the housing or arranged inside the housing. In the latter case, a separate sensor housing can be dispensed with, which means a further saving on costs. However, it must be ensured that the belt retractor does not have an effect on the sensitivity of the electric impact sensor.

The installation of the assembly unit can be further simplified by the electric impact sensor and the belt retractor sharing at least one common fastening element, i.e. an element which is provided for fastening the belt retractor serves at the same time for fastening the electric impact sensor.

The safety device according to the invention proves to be particularly advantageous when the belt retractor is an electric belt retractor. Instead of a separate wiring of the electric impact sensor, this can be integrated into the wiring of the belt retractor, whereby the expenditure on wiring as a whole is considerably reduced.

The invention also provides a vehicle occupant protection system in a motor vehicle with a safety device according to the invention.

It proves to be expedient to mount the safety device according to the invention to a B- or a C-column of the vehicle, which are the areas where belt retractors are usually arranged. Moreover, these areas are suitable for the positioning of the electric impact sensor. With such an arrangement, the electric impact sensor then serves as a side impact sensor.

However, an application is also conceivable in which the electric impact sensor serves as a rear impact sensor to detect a rear impact, namely when the safety device according to the invention is placed with the belt retractor in the region of a back rest of a rear bench seat or in the region of a rear parcel shelf of the vehicle.

### BRIEF DESCRIPTION OF THE DRAWINGS

FIG. 1 shows the arrangement of a belt retractor and of an electric impact sensor according to the prior art;

FIG. 2 shows a sectional view along the line II-II in FIG. 1;

FIG. 3 shows a safety device according to the invention in a perspective view in a position before installation;

FIG. 4 shows the safety device of FIG. 3 in the installation position;

FIG. 5 shows a front passenger airbag module in the installed state in a sectional view;

FIG. 6 shows the front passenger airbag module of FIG. 5 in a perspective view;

FIG. 7 shows a knee airbag module in the installed state in a sectional view; and

FIG. 8 shows a side airbag module in the installed state in a sectional view.

### DETAILED DESCRIPTION OF THE PREFERRED EMBODIMENTS

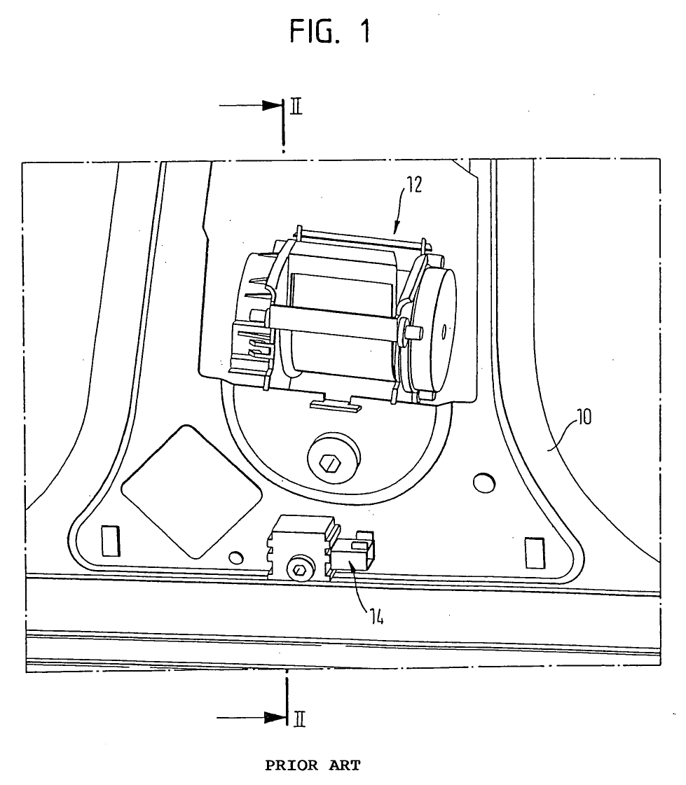

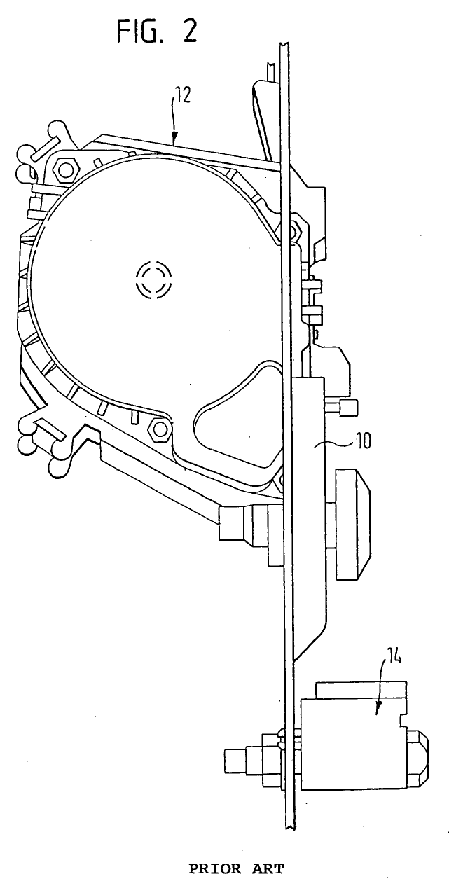

In FIGS. 1 and 2 a side body part 10 of a motor vehicle is illustrated, to which a belt retractor 12 is fastened. An electric impact sensor 14 is fastened separately to the body part 10, independently of the belt retractor 12. The electric impact sensor 14 is a side impact sensor for activating a side airbag module of the vehicle, i.e. it is not in direct functional connection with the belt retractor 12, but with a different vehicle occupant protection arrangement.

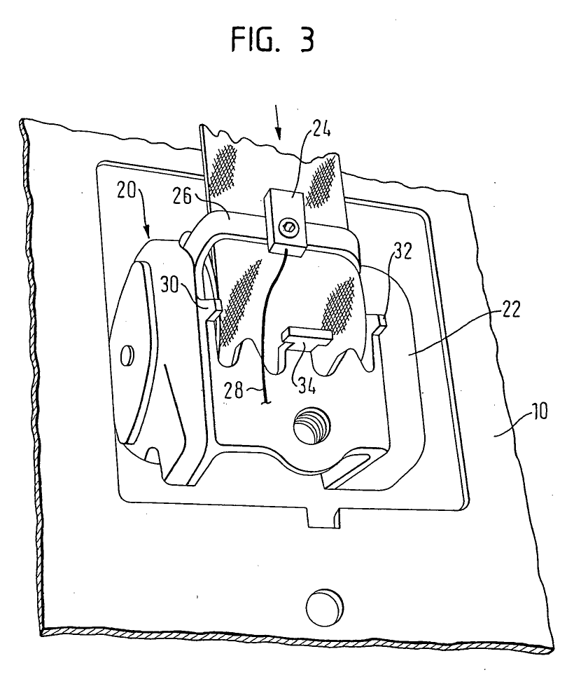

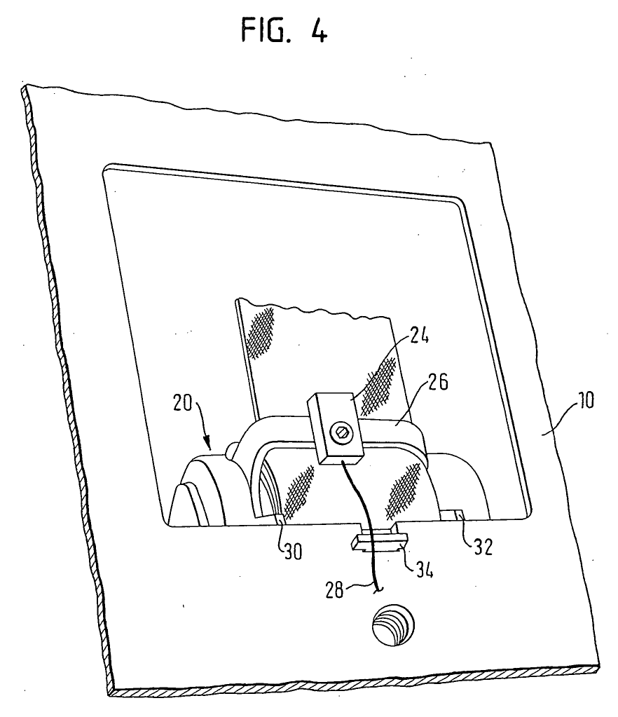

FIGS. 3 and 4 show a safety device according to the invention with a belt retractor 20, the essential components of which are held together by a housing 22, and with an electric impact sensor 24. Here, too, the electric impact sensor 24 is a side impact sensor for activating a side airbag module of the vehicle.

The belt retractor 20 and the electric impact sensor 24 jointly form a pre-assembled unit. The electric impact sensor 24 is arranged on a cross-piece 26 of the belt retractor housing 22. In the case of an electric belt retractor, the wiring 28 of the electric impact sensor 24 is placed together with the wiring of the belt retractor 20 so that a single plug connector is sufficient for the connection of the belt retractor 20 and the electric impact sensor 24.

The electric impact sensor 24 may also be fastened at different locations, e.g. on the projecting sections designated by 30 and 32, or on the element 34, which would then be respectively increased in size accordingly.

The safety device may be arranged in the region of a B- or C-column of the vehicle or in the region of a back rest of a rear bench seat or in the region of a rear parcel shelf, in particular when the belt retractor 20 is provided for the middle seat in a rear bench seat.

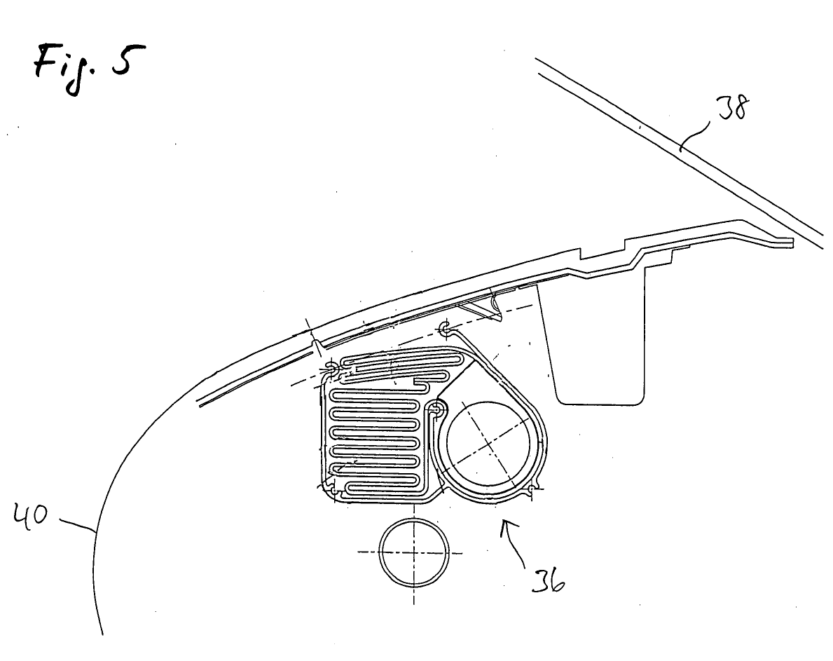

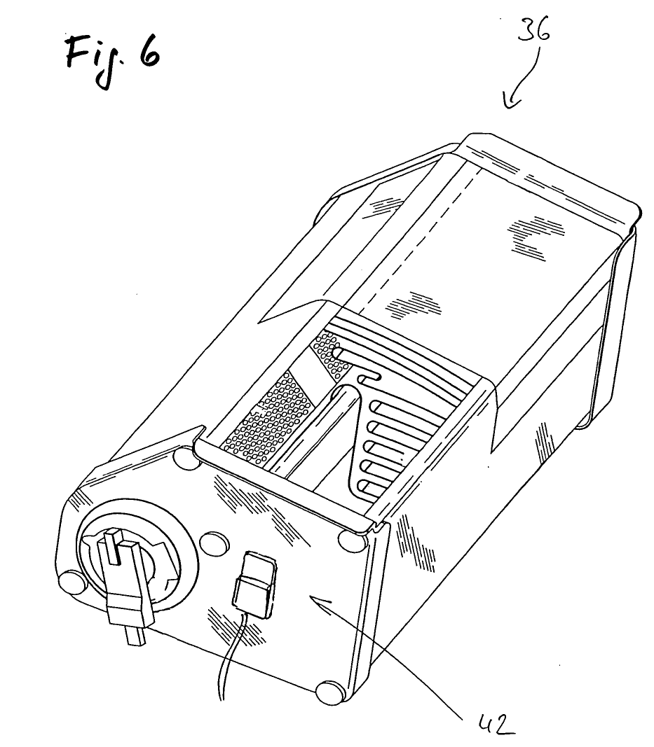

FIGS. 5 and 6 show a further safety device according to the invention in the form of a front passenger airbag module 36. The module 36 is arranged between the windshield 38 of the vehicle and the region of the instrument panel 40 facing the occupant. An electric impact sensor 42 is fastened to an outer wall on the end face of the module 36. (The sensor 42 may, however, also be mounted at any other suitable location of the module 36.) The sensor 42 is either an acceleration sensor provided for activating the front passenger airbag module 36 or a sensor for a different vehicle occupant protection arrangement, e.g., a side impact sensor for activating a side airbag module of the vehicle. The sensor 42 may be wired by means of separately arranged wires or, preferably, its wiring may run in the cable harness, provided at any rate, of the module 36.

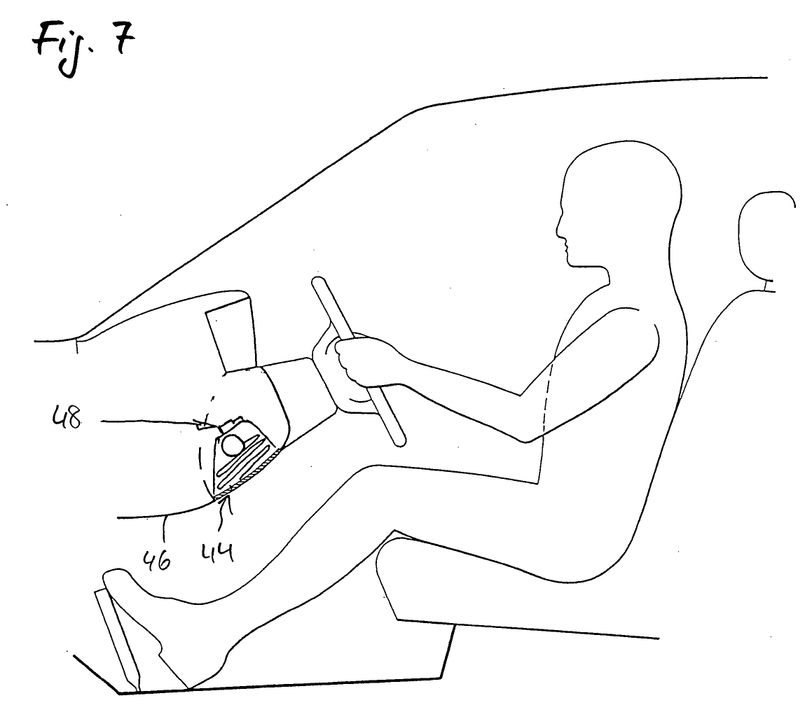

FIG. 7 shows a safety device according to the invention in the form of a knee airbag module 44. The module 44 is arranged behind a wall 46 delimiting the footwell. An electric impact sensor 48 is fastened to an outer wall of the module 44. (The sensor 48 may, however, also be mounted at any other suitable location of the module 44.) The sensor 48 is either an acceleration sensor provided for activating the knee airbag module 44 or a sensor for a different vehicle occupant protection arrangement, e.g., a side impact sensor for activating a side airbag module of the vehicle. The sensor 48 may be wired by means of separately arranged wires or, preferably, its wiring may run in the cable harness, provided at any rate, of the module 44.

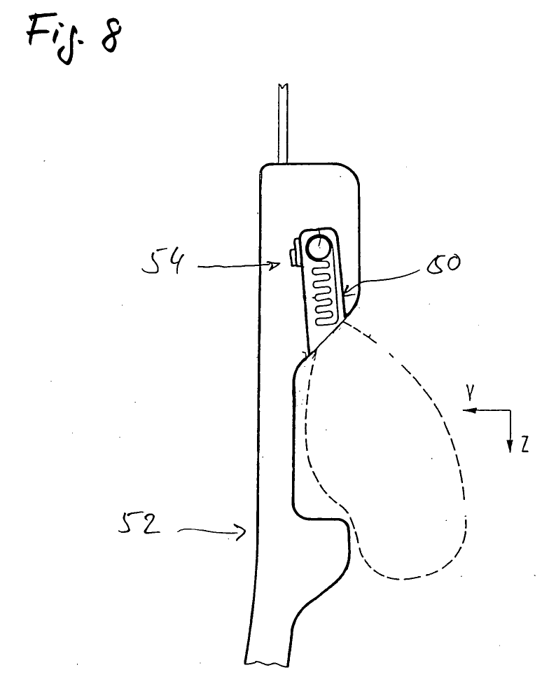

FIG. 8 shows a safety device according to the invention in the form of a side airbag module 50. The module 50 is integrated in a vehicle door 52 or is accommodated in another structural space of the vehicle side structure. An electric impact sensor 54 is fastened to an outer wall of the module 50. (The sensor 54 may, however, also be mounted at any other suitable location of the module 50.) The sensor 54 is either an acceleration sensor provided for activating the side airbag module 50 or a sensor for a different vehicle occupant protection arrangement, e.g., an (additional) impact sensor for activating a front airbag module of the vehicle. The sensor 54 may be wired by means of separately arranged wires or, preferably, its wiring may run in the cable harness, provided at any rate, of the module 50.

1. A safety device for a motor vehicle, the safety device comprising a vehicle occupant protection arrangement installed as a unit in the vehicle, and an electric impact sensor, the vehicle occupant protection arrangement installed as a unit in the vehicle and the electric impact sensor forming a preassembled unit.

2. The safety device according to claim 1, wherein the electric impact sensor is a side impact sensor for activating a side airbag module of the vehicle.

3. The safety device according to claim 1, wherein the vehicle occupant protection arrangement is a belt retractor.

4. The safety device according to claim 3, wherein the belt retractor has a housing and the electric impact sensor is fitted to an outside of the housing.

5. The safety device according to claim 3, wherein the belt retractor has a housing and the electric impact sensor is arranged inside the housing.

6. The safety device according to claim 3, wherein the impact sensor and the belt retractor share at least one common fastening element.

7. The safety device according to claim 3, wherein the belt retractor is an electric belt retractor.

8. The safety device according to claim 1, wherein the vehicle occupant protection arrangement is a front airbag module.

9. The safety device according to claim 8, wherein the vehicle occupant protection arrangement is a front passenger airbag module.

10. The safety device according to claim 1, wherein the vehicle occupant protection arrangement is a knee airbag module.

11. The safety device according to claim 1, wherein the vehicle occupant protection arrangement is a side airbag module.

12. A vehicle occupant protection system in a motor vehicle, comprising a safety device according to claim 1, wherein the safety device is mounted to a B- or a C-column of the vehicle.

13. A vehicle occupant protection system in a motor vehicle, comprising a safety device according to claim 1, wherein the safety device is arranged in a region of a back rest of a rear bench seat or in a region of a rear parcel shelf of the vehicle.

14. A vehicle occupant protection system in a motor vehicle, comprising a safety device according to claim 8, wherein the safety device is arranged in a region between a windshield of the vehicle and an area of an instrument panel facing the occupant.

15. A vehicle occupant protection system in a motor vehicle, comprising a safety device according to claim 10, characterized in that the safety device is arranged in a region behind a wall delimiting a footwell.

16. A vehicle occupant protection system in a motor vehicle, comprising a safety device according to claim 11, characterized in that the safety device is integrated in a vehicle door.

17. A vehicle occupant protection system in a motor vehicle, comprising a safety device according to claim 11, wherein the safety device is accommodated in a structural space of a vehicle side structure.
